(19) United States
(12) Patent Application Publication
(10) Pub. No.: US 2024/0126606 A1
(43) Pub. Date: Apr. 18, 2024

(54) DYNAMIC PARALLEL PROCESSING IN AN EDGE COMPUTING SYSTEM

(71) Applicants: Akhilesh Thyagaturu, Tampa, FL (US); Jonathan L. Kyle, Atlanta, GA (US); Karthik Kumar, Chandler, AZ (US); Francesc Guim Bernat, Barcelona (ES); Mohit Kumar Garg, Hisar (IN)

(72) Inventors: Akhilesh Thyagaturu, Tampa, FL (US); Jonathan L. Kyle, Atlanta, GA (US); Karthik Kumar, Chandler, AZ (US); Francesc Guim Bernat, Barcelona (ES); Mohit Kumar Garg, Hisar (IN)

(21) Appl. No.: 18/397,807

(22) Filed: Dec. 27, 2023

(51) Int. Cl. G06F 9/50

(52) U.S. Cl. CPC G06F 9/5027

(57) ABSTRACT

Data that is to be processed by a particular service executed by a first edge computing device in an application, is analyzed to determine characteristics of the data. An opportunity to replicate the particular service on a plurality of edge computing devices is determined based on characteristics of the data. A second edge computing device is determined to be available to execute a replicated instance of the particular service. Replication of the particular service is initiated on a plurality of edge computing devices including the second edge computing device. An output of an instance of the particular service executed on the first edge computing device and an output of the replicated instance of the particular service executed on the second edge computing device are combined to form a single output for the particular service.

### TECHNICAL FIELD

This disclosure relates in general to the field of computer networking, and more particularly, though not exclusively, to establishing parallel processing pipelines in edge computing networks.

### BACKGROUND

Edge computing, including mobile edge computing, may offer application developers and content providers cloud-computing capabilities and an information technology service environment at the edge of a network. Edge computing may have some advantages when compared to traditional centralized cloud computing environments. For example, edge computing may provide a service to a user equipment (UE) with a lower latency, a lower cost, a higher bandwidth, a closer proximity, or an exposure to real-time radio network and context information.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 illustrates an overview of an Edge cloud configuration for edge computing.

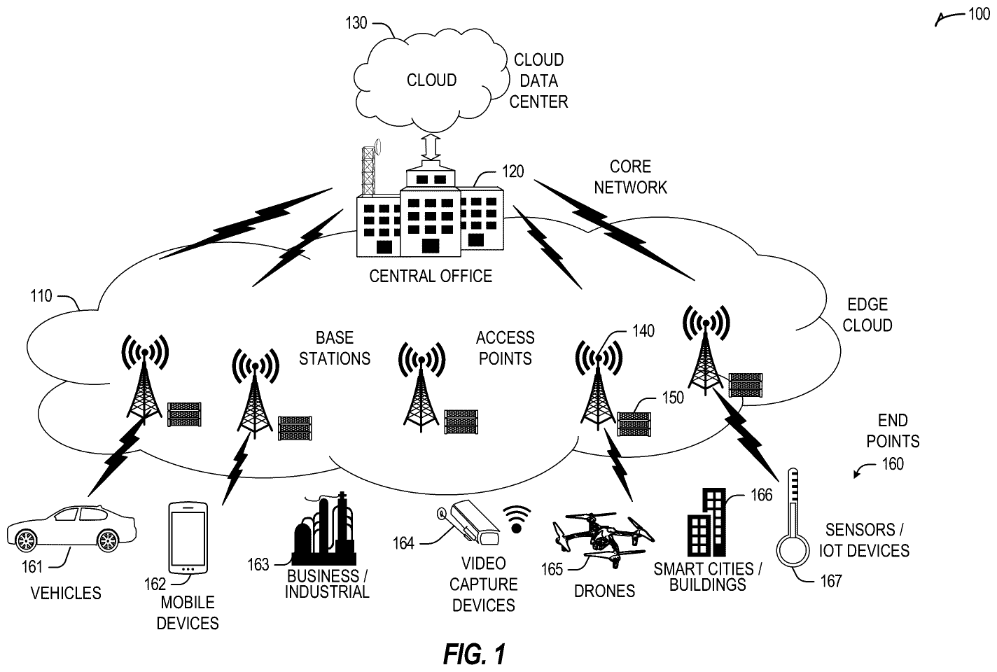

FIG. 2 illustrates operational layers among endpoints, an edge cloud, and cloud computing environments.

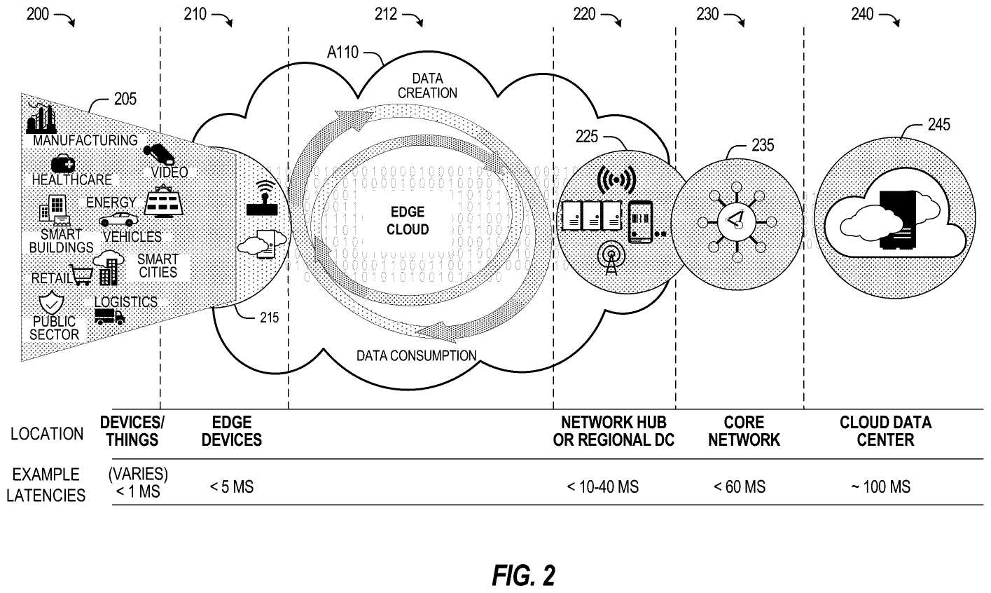

FIG. 3 illustrates an example approach for networking and services in an edge computing system.

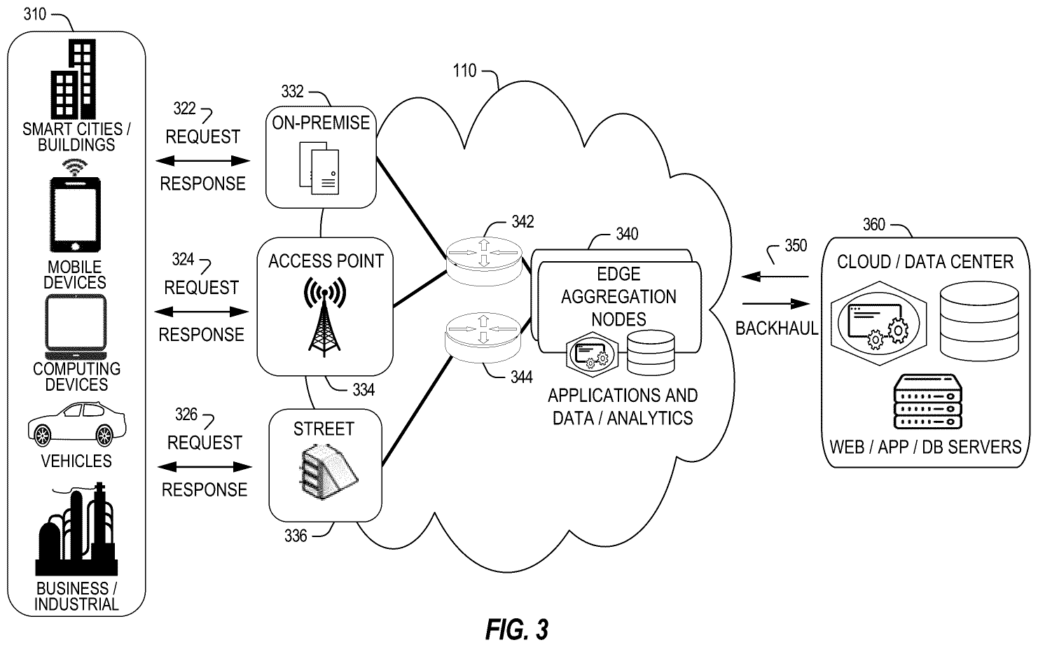

FIG. 4 illustrates a block diagram for an example edge computing device.

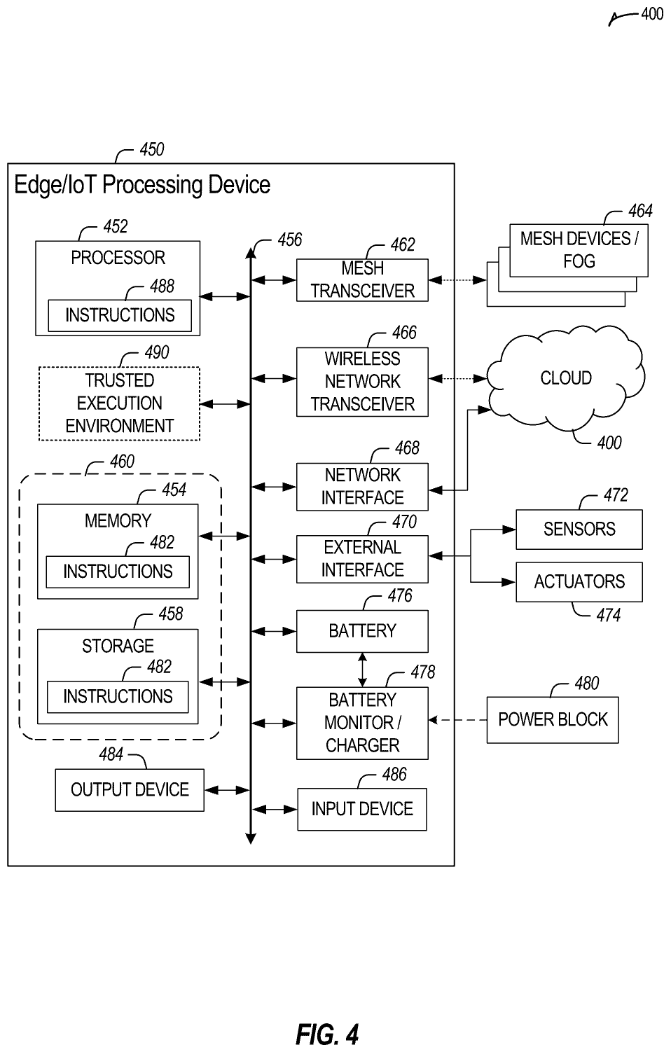

FIG. 5 illustrates an overview of layers of distributed compute deployed among an edge computing system.

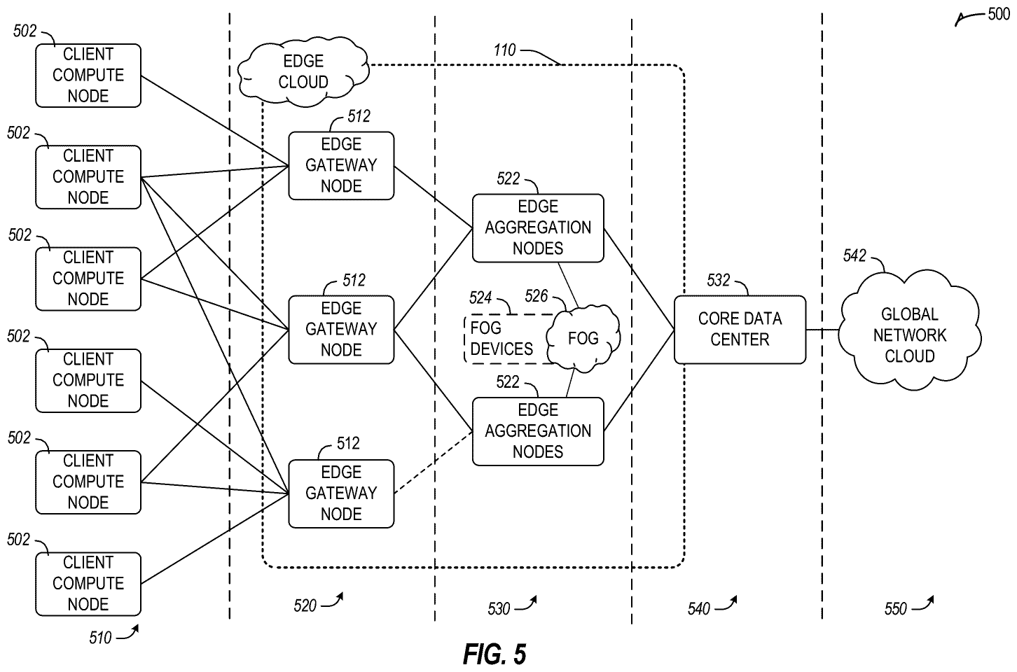

FIG. 6 illustrates a block diagram of an example end-to-end application using an edge computing system.

FIG. 7 illustrates a block diagram of an example end-to-end application using an edge computing system including dynamic replication of services.

FIG. 8 illustrates a block diagram of an example edge computing system including data scaling operations.

FIG. 9 illustrates a block diagram of an example edge computing system including multiple data pre-processing stages.

FIG. 10 illustrates a block diagram of an example computing system including dynamic replication of services.

FIG. 11 is a simplified flow diagram showing an example technique for launching parallel data processing pipelines.

FIG. 12 is a simplified block diagram showing an example implementation of an application utilizing dynamic replication of services.

FIG. 13 is a flow diagram showing an example implementation of an application utilizing dynamic replication of services.

FIG. 14 is a flow diagram showing a specific example of an application utilizing dynamic replication of services.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

FIG. Error! Reference source not found. is a block diagram Error! Reference source not found.00 showing an overview of a configuration for edge computing, which includes a layer of processing referred to in many of the following examples as an “edge cloud” or “edge system”. As shown, the edge cloud Error! Reference source not found.10 is co-located at an edge location, such as an access point or base station Error! Reference source not found.40, a local processing hub Error! Reference source not found.50, or a central office Error! Reference source not found.20, and thus may include multiple entities, devices, and equipment instances. The edge cloud Error! Reference source not found.10 is located much closer to the endpoint (consumer and producer) data sources Error! Reference source not found.60 (e.g., autonomous vehicles Error! Reference source not found.61, user equipment Error! Reference source not found.62, business and industrial equipment Error! Reference source not found.63, video capture devices Error! Reference source not found.64, drones Error! Reference source not found.65, smart cities and building devices Error! Reference source not found.66, sensors and IoT devices Error! Reference source not found.67, etc.) than the cloud data center Error! Reference source not found.30. Compute, memory, and storage resources which are offered at the edges in the edge cloud Error! Reference source not found.10 may be leveraged to provide ultra-low latency response times for services and functions used by the endpoint data sources Error! Reference source not found.60 as well as reduce network backhaul traffic from the edge cloud Error! Reference source not found.10 toward cloud data center Error! Reference source not found.30 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the resources needed for network services, through the distribution of more resources which are located closer both geographically and in network access time. In this manner, edge computing attempts to bring the compute resources to the workload data where appropriate, or bring the workload data to the compute resources.

Edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” (e.g., migrated) to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

FIG. Error! Reference source not found. illustrates operational layers among endpoints, an edge cloud, and cloud computing environments. Specifically, FIG. Error! Reference source not found. depicts examples of computational use cases Error! Reference source not found.05, utilizing the edge cloud Error! Reference source not found.10 among multiple illustrative layers of network computing. The layers begin at an endpoint (devices and things) layer Error! Reference source not found.00, which accesses the edge cloud Error! Reference source not found.10 to conduct data creation, analysis, and data consumption activities. The edge cloud Error! Reference source not found.10 may span multiple network layers, such as an edge devices layer Error! Reference source not found.10 having gateways, on-premise servers, or network equipment (nodes Error! Reference source not found.15) located in physically proximate edge systems; a network access layer Error! Reference source not found.20, encompassing base stations, radio processing units, network hubs, regional data centers (DC), or local network equipment (equipment Error! Reference source not found.25); and any equipment, devices, or nodes located therebetween (in layer Error! Reference source not found.12, not illustrated in detail). The network communications within the edge cloud Error! Reference source not found.10 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer Error! Reference source not found.00, under 5 ms at the edge devices layer Error! Reference source not found.10, to even between 10 to 40 ms when communicating with nodes at the network access layer Error! Reference source not found.20. Beyond the edge cloud Error! Reference source not found.10 are core network Error! Reference source not found.30 and cloud data center Error! Reference source not found.40 layers, each with increasing latency (e.g., between 50-60 ms at the core network layer Error! Reference source not found.30, to 100 or more ms at the cloud data center layer). As a result, operations at a core network data center Error! Reference source not found.35 or a cloud data center Error! Reference source not found.45, with latencies of at least 50 to 100 ms or more, will not be able to accomplish many time-critical functions of the use cases Error! Reference source not found.05. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center Error! Reference source not found.35 or a cloud data center Error! Reference source not found.45, a central office or content data network may be considered as being located within a “near edge” layer (“near” to the cloud, having high latency values when communicating with the devices and endpoints of the use cases Error! Reference source not found.05), whereas an access point, base station, on-premise server, or network gateway may be considered as located within a “far edge” layer (“far” from the cloud, having low latency values when communicating with the devices and endpoints of the use cases Error! Reference source not found.05). It will be understood that other categorizations of a particular network layer as constituting a “close”, “local”, “near”, “middle”, or “far” edge may be based on latency, distance, number of network hops, or other measurable characteristics, as measured from a source in any of the network layers Error! Reference source not found.00-Error! Reference source not found.40.

The various use cases Error! Reference source not found.05 may access resources under usage pressure from incoming streams, due to multiple services utilizing the edge cloud. To achieve results with low latency, the services executed within the edge cloud Error! Reference source not found.10 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); (c) Physical constraints (e.g., power, cooling and form-factor, etc.); and (d) contractual agreements (e.g., Service Level Agreements (SLA) or Service Level Objectives (SLO)).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to Service Level Agreement (SLA), the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud Error! Reference source not found.10 may provide the ability to serve and respond to multiple applications of the use cases Error! Reference source not found.05 (e.g., object tracking, video surveillance, connected cars, etc.) in real-time or near real-time, and meet ultra-low latency requirements for these multiple applications. These advantages enable a whole new class of applications (e.g., Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following traditional caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required because edge locations may be unmanned and may even need permissioned access (e.g., when housed in a third-party location). Such issues may be magnified in the edge cloud Error! Reference source not found.10 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud Error! Reference source not found.10 (network layers Error! Reference source not found.00-Error! Reference source not found.40), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, “TSP”, or communication service providers (CmSP)), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud Error! Reference source not found.10.

As such, the edge cloud Error! Reference source not found.10 is formed from network components and functional features operated by and within edge gateway nodes, edge aggregation nodes, or other edge compute nodes among network layers Error! Reference source not found.10-Error! Reference source not found.30. The edge cloud Error! Reference source not found.10 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud Error! Reference source not found.10 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks, etc.) may also be utilized in place of or in combination with such 3GPP carrier networks.

In FIG. Error! Reference source not found., various client endpoints Error! Reference source not found.10 (in the form of mobile devices, computers, autonomous vehicles, business computing equipment, industrial processing equipment) exchange requests and responses that are specific to the type of endpoint network aggregation. For instance, client endpoints Error! Reference source not found.10 may obtain network access via a wired broadband network, by exchanging requests and responses Error! Reference source not found.22 through an on-premise network system Error! Reference source not found.32. Some client endpoints Error! Reference source not found.10, such as mobile computing devices, may obtain network access via a wireless broadband network, by exchanging requests and responses Error! Reference source not found.24 through an access point (e.g., a cellular network tower) Error! Reference source not found.34. Some client endpoints Error! Reference source not found.10, such as autonomous vehicles may obtain network access for requests and responses Error! Reference source not found.26 via a wireless vehicular network through a street-located network system Error! Reference source not found.36. However, regardless of the type of network access, the TSP may deploy aggregation points Error! Reference source not found.42, Error! Reference source not found.44 within the edge cloud Error! Reference source not found.10 to aggregate traffic and requests. Thus, within the edge cloud Error! Reference source not found.10, the TSP may deploy various compute and storage resources, such as at edge aggregation nodes Error! Reference source not found.40, to provide requested content. The edge aggregation nodes Error! Reference source not found.40 and other systems of the edge cloud Error! Reference source not found.10 are connected to a cloud or data center Error! Reference source not found.60, which uses a backhaul network Error! Reference source not found.50 to fulfill higher-latency requests from a cloud/data center for websites, applications, database servers, etc. Additional or consolidated instances of the edge aggregation nodes Error! Reference source not found.40 and the aggregation points Error! Reference source not found.42, Error! Reference source not found.44, including those deployed on a single server framework, may also be present within the edge cloud Error! Reference source not found.10 or other areas of the TSP infrastructure.

FIG. Error! Reference source not found. is a block diagram of an example of components that may be present in an example edge computing device Error! Reference source not found.50 for implementing the techniques described herein. The edge device Error! Reference source not found.50 may include any combinations of the components shown in the example or referenced in the disclosure above. The components may be implemented as ICs, intellectual property blocks, portions thereof, discrete electronic devices, or other modules, logic, hardware, software, firmware, or a combination thereof adapted in the edge device Error! Reference source not found.50, or as components otherwise incorporated within a chassis of a larger system. Additionally, the block diagram of FIG. Error! Reference source not found. is intended to depict a high-level view of components of the edge device Error! Reference source not found.50. However, some of the components shown may be omitted, additional components may be present, and different arrangement of the components shown may occur in other implementations.

The edge device Error! Reference source not found.50 may include processor circuitry in the form of, for example, a processor Error! Reference source not found.52, which may be a microprocessor, a multi-core processor, a multithreaded processor, an ultra-low voltage processor, an embedded processor, or other known processing elements. The processor Error! Reference source not found.52 may be a part of a system on a chip (SoC) in which the processor Error! Reference source not found.52 and other components are formed into a single integrated circuit, or a single package. The processor Error! Reference source not found.52 may communicate with a system memory Error! Reference source not found.54 over an interconnect Error! Reference source not found.56 (e.g., a bus). Any number of memory devices may be used to provide for a given amount of system memory. To provide for persistent storage of information such as data, applications, operating systems and so forth, a storage Error! Reference source not found.58 may also couple to the processor Error! Reference source not found.52 via the interconnect Error! Reference source not found.56. In an example the storage Error! Reference source not found.58 may be implemented via a solid state disk drive (SSDD). Other devices that may be used for the storage Error! Reference source not found.58 include flash memory cards, such as SD cards, microSD cards, xD picture cards, and the like, and USB flash drives. In low power implementations, the storage Error! Reference source not found.58 may be on-die memory or registers associated with the processor Error! Reference source not found.52. However, in some examples, the storage Error! Reference source not found.58 may be implemented using a micro hard disk drive (HDD). Further, any number of new technologies may be used for the storage Error! Reference source not found.58 in addition to, or instead of, the technologies described, such resistance change memories, phase change memories, holographic memories, or chemical memories, among others.

The components may communicate over the interconnect Error! Reference source not found.56. The interconnect Error! Reference source not found.56 may include any number of technologies, including PCI express (PCIe), Compute Express Link (CXL), NVLink, HyperTransport, or any number of other technologies. The interconnect Error! Reference source not found.56 may be a proprietary bus, for example, used in a SoC based system. Other bus systems may be included, such as an I2C interface, an SPI interface, point to point interfaces, and a power bus, among others.

Given the variety of types of applicable communications from the device to another component or network, applicable communications circuitry used by the device may include or be embodied by any one or more of components Error! Reference source not found.62, Error! Reference source not found.66, Error! Reference source not found.68, or Error! Reference source not found.70. Accordingly, in various examples, applicable means for communicating (e.g., receiving, transmitting, etc.) may be embodied by such communications circuitry. For instance, the interconnect Error! Reference source not found.56 may couple the processor Error! Reference source not found.52 to a mesh transceiver Error! Reference source not found.62, for communications with other mesh devices Error! Reference source not found.64. The mesh transceiver Error! Reference source not found.62 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. The mesh transceiver Error! Reference source not found.62 may communicate using multiple standards or radios for communications at different ranges.

A wireless network transceiver Error! Reference source not found.66 may be included to communicate with devices or services in the cloud Error! Reference source not found.00 via local or wide area network protocols. For instance, the edge device Error! Reference source not found.50 may communicate over a wide area using LoRaWAN™ (Long Range Wide Area Network), among other example technologies. Indeed, any number of other radio communications and protocols may be used in addition to the systems mentioned for the mesh transceiver Error! Reference source not found.62 and wireless network transceiver Error! Reference source not found.66, as described herein. For example, the radio transceivers Error! Reference source not found.62 and Error! Reference source not found.66 may include an LTE or other cellular transceiver that uses spread spectrum (SPA/SAS) communications for implementing high speed communications. Further, any number of other protocols may be used, such as Wi-Fi® networks for medium speed communications and provision of network communications. A network interface controller (NIC) Error! Reference source not found.68 may be included to provide a wired communication to the cloud Error! Reference source not found.00 or to other devices, such as the mesh devices Error! Reference source not found.64. The wired communication may provide an Ethernet connection, or may be based on other types of networks, protocols, and technologies.

The interconnect Error! Reference source not found.56 may couple the processor Error! Reference source not found.52 to an external interface Error! Reference source not found.70 that is used to connect external devices or subsystems. The external devices may include sensors Error! Reference source not found.72, such as accelerometers, level sensors, flow sensors, optical light sensors, camera sensors, temperature sensors, a global positioning system (GPS) sensors, pressure sensors, barometric pressure sensors, and the like. The external interface Error! Reference source not found.70 further may be used to connect the edge device Error! Reference source not found.50 to actuators Error! Reference source not found.74, such as power switches, valve actuators, an audible sound generator, a visual warning device, and the like.

In some optional examples, various input/output (I/O) devices may be present within, or connected to, the edge device Error! Reference source not found.50. Further, some edge computing devices may be battery powered and include one or more batteries (e.g., 476) to power the device. In such instances, a battery monitor/charger Error! Reference source not found.78 may be included in the edge device Error! Reference source not found.50 to track the state of charge (SoCh) of the battery Error! Reference source not found.76. The battery monitor/charger Error! Reference source not found.78 may be used to monitor other parameters of the battery Error! Reference source not found.76 to provide failure predictions, such as the state of health (SoH) and the state of function (SoF) of the battery Error! Reference source not found.76, which may trigger an edge system to attempt to provision other hardware (e.g., in the edge cloud or a nearby cloud system) to supplement or replace a device whose power is failing, among other example uses. In some instances, the device 450 may also or instead include a power block Error! Reference source not found.80, or other power supply coupled to a grid, may be coupled with the battery monitor/charger Error! Reference source not found.78 to charge the battery Error! Reference source not found.76. In some examples, the power block Error! Reference source not found.80 may be replaced with a wireless power receiver to obtain the power wirelessly, for example, through a loop antenna in the edge device Error! Reference source not found.50, among other examples.

The storage Error! Reference source not found.58 may include instructions Error! Reference source not found.82 in the form of software, firmware, or hardware commands to implement the workflows, services, microservices, or applications to be carried out in transactions of an edge system, including techniques described herein. Although such instructions Error! Reference source not found.82 are shown as code blocks included in the memory Error! Reference source not found.54 and the storage Error! Reference source not found.58, it may be understood that any of the code blocks may be replaced with hardwired circuits, for example, built into an application specific integrated circuit (ASIC). In some implementations, hardware of the edge computing device 450 (separately, or in combination with the instructions Error! Reference source not found.88) may configure execution or operation of a trusted execution environment (TEE) Error! Reference source not found.90. In an example, the TEE Error! Reference source not found.90 operates as a protected area accessible to the processor Error! Reference source not found.52 for secure execution of instructions and secure access to data, among other example features.

At a more generic level, an edge computing system may be described to encompass any number of deployments operating in an edge cloud Error! Reference source not found.10, which provide coordination from client and distributed computing devices. FIG. Error! Reference source not found. provides a further abstracted overview of layers of distributed compute deployed among an edge computing environment for purposes of illustration. For instance, FIG. Error! Reference source not found. generically depicts an edge computing system for providing edge services and applications to multi-stakeholder entities, as distributed among one or more client compute nodes Error! Reference source not found.02, one or more edge gateway nodes Error! Reference source not found.12, one or more edge aggregation nodes Error! Reference source not found.22, one or more core data centers Error! Reference source not found.32, and a global network cloud Error! Reference source not found.42, as distributed across layers of the network. The implementation of the edge computing system may be provided at or on behalf of a telecommunication service provider (“telco”, or “TSP”), internet-of-things service provider, cloud service provider (CSP), enterprise entity, or any other number of entities.

Each node or device of the edge computing system is located at a particular layer corresponding to layers Error! Reference source not found.10, Error! Reference source not found.20, Error! Reference source not found.30, Error! Reference source not found.40, Error! Reference source not found.50. For example, the client compute nodes Error! Reference source not found.02 are each located at an endpoint layer Error! Reference source not found.10, while each of the edge gateway nodes Error! Reference source not found.12 are located at an edge devices layer Error! Reference source not found.20 (local level) of the edge computing system. Additionally, each of the edge aggregation nodes Error! Reference source not found.22 (and/or fog devices Error! Reference source not found.24, if arranged or operated with or among a fog networking configuration Error! Reference source not found.26) are located at a network access layer Error! Reference source not found.30 (an intermediate level). Fog computing (or “fogging”) generally refers to extensions of cloud computing to the edge of an enterprise's network, typically in a coordinated distributed or multi-node network. Some forms of fog computing provide the deployment of compute, storage, and networking services between end devices and cloud computing data centers, on behalf of the cloud computing locations. Such forms of fog computing provide operations that are consistent with edge computing as discussed herein; many of the edge computing aspects discussed herein are applicable to fog networks, fogging, and fog configurations. Further, aspects of the edge computing systems discussed herein may be configured as a fog, or aspects of a fog may be integrated into an edge computing architecture.

The core data center Error! Reference source not found.32 is located at a core network layer Error! Reference source not found.40 (e.g., a regional or geographically-central level), while the global network cloud Error! Reference source not found.42 is located at a cloud data center layer Error! Reference source not found.50 (e.g., a national or global layer). The use of “core” is provided as a term for a centralized network location—deeper in the network—which is accessible by multiple edge nodes or components; however, a “core” does not necessarily designate the “center” or the deepest location of the network. Accordingly, the core data center Error! Reference source not found.32 may be located within, at, or near the edge cloud Error! Reference source not found.10.

Although an illustrative number of client compute nodes Error! Reference source not found.02, edge gateway nodes Error! Reference source not found.12, edge aggregation nodes Error! Reference source not found.22, core data centers Error! Reference source not found.32, global network clouds Error! Reference source not found.42 are shown in FIG. Error! Reference source not found., it should be appreciated that the edge computing system may include more or fewer devices or systems at each layer. Additionally, as shown in FIG. Error! Reference source not found., the number of components of each layer Error! Reference source not found.10, Error! Reference source not found.20, Error! Reference source not found.30, Error! Reference source not found.40, Error! Reference source not found.50 generally increases at each lower level (i.e., when moving closer to endpoints). As such, one edge gateway node Error! Reference source not found.12 may service multiple client compute nodes Error! Reference source not found.02, and one edge aggregation node Error! Reference source not found.22 may service multiple edge gateway nodes Error! Reference source not found.12.

Consistent with the examples provided herein, each client compute node Error! Reference source not found.02 may be embodied as any type of end point component, device, appliance, or “thing” capable of communicating as a producer or consumer of data. Further, the label “node” or “device” as used in the edge computing system Error! Reference source not found.00. As such, the edge cloud Error! Reference source not found.10 is formed from network components and functional features operated by and within the edge gateway nodes Error! Reference source not found.12 and the edge aggregation nodes Error! Reference source not found.22 of layers Error! Reference source not found.20, Error! Reference source not found.30, respectively. The edge cloud Error! Reference source not found.10 may be embodied as any type of network that provides edge computing and/or storage resources which are proximately located to radio access network (RAN) capable endpoint devices (e.g., mobile computing devices, IoT devices, smart devices, etc.), which are shown in FIG. Error! Reference source not found. as the client compute nodes Error! Reference source not found.02. In other words, the edge cloud Error! Reference source not found.10 may be envisioned as an “edge” which connects the endpoint devices and traditional mobile network access points that serves as an ingress point into service provider core networks, including carrier networks (e.g., Global System for Mobile Communications (GSM) networks, Long-Term Evolution (LTE) networks, 5G networks, etc.), while also providing storage and/or compute capabilities. Other types and forms of network access (e.g., Wi-Fi, long-range wireless networks) may also be utilized in place of or in combination with such 3GPP carrier networks.

In some examples, the edge cloud Error! Reference source not found.10 may form a portion of or otherwise provide an ingress point into or across a fog networking configuration Error! Reference source not found.26 (e.g., a network of fog devices Error! Reference source not found.24, not shown in detail), which may be embodied as a system-level horizontal and distributed architecture that distributes resources and services to perform a specific function. For instance, a coordinated and distributed network of fog devices Error! Reference source not found.24 may perform computing, storage, control, or networking aspects in the context of an IoT system arrangement. Other networked, aggregated, and distributed functions may exist in the edge cloud Error! Reference source not found.10 between the cloud data center layer Error! Reference source not found.50 and the client endpoints (e.g., client compute nodes Error! Reference source not found.02).

The edge gateway nodes Error! Reference source not found.12 and the edge aggregation nodes Error! Reference source not found.22 cooperate to provide various edge services and security to the client compute nodes Error! Reference source not found.02. Furthermore, because each client compute node Error! Reference source not found.02 may be stationary or mobile, each edge gateway node Error! Reference source not found.12 may cooperate with other edge gateway devices to propagate presently provided edge services and security as the corresponding client compute node Error! Reference source not found.02 moves about a region. To do so, each of the edge gateway nodes Error! Reference source not found.12 and/or edge aggregation nodes Error! Reference source not found.22 may support multiple tenancy and multiple stakeholder configurations, in which services from (or hosted for) multiple service providers and multiple consumers may be supported and coordinated across a single or multiple compute devices.

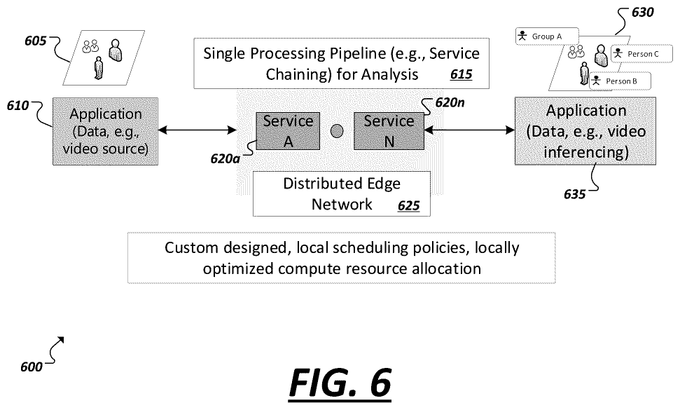

Edge computing systems, such as introduced above, may be utilized to provide hardware and logic to implement various applications and services. For instance, as illustrated in the simplified block diagram 600 of FIG. 6, an application 610 may be defined to perform various operations on a various data (e.g., 605), which is provided as an input to the application. In traditional edge applications, a chain of one or more services (e.g., 620a-620n) may operate upon the data to implement the end-to-end application. For instance, a first service (e.g., 620a) may be programmatically configured to perform a first set of operations on the data 605 to transform the data and/or derive additional data (e.g., metadata, inference results, tag or labels, etc.). The output of the first service 620a may be provided as an input to another service in the chain, which may operate on this output to generate another output and so forth until a final output 630 of the final service 620n is generated in the chain for the application. This output may be provided to another application, data store, or other system (e.g., 635). The various services 620a-n in the application may be executed on one or more edge computing devices in a distributed edge network 625. In some cases, a single edge computing device may execute each of the services in the service chain, although advantageously, multiple edge computing devices may be utilized in other instances to execute the multiple services. In traditional edge computing systems, a single processing pipeline 615 is implemented, such as illustrated in the example of FIG. 6, where the application is predefined to operate on particular expected data (e.g., 605) according to a custom designed pipeline with scheduling policies and computing resource allocation optimized at a local, edge-device level.

While edge-based application implementations may effectively manage edge resources and meet the defined service level requirements or agreements (e.g., SLAs) for the application, such applications may not be able to maintain such performance dynamically when variances and complexities emerge in the data to be processed. For instance, in the example of FIG. 6, the application 610 may be designed to identify a person in image data, as well as certain characteristics of the person (e.g., predicted age, gender, identification, gestures, location within a scene, etc.). A chain of services 620a-n, in one example, may be designed to determine such characteristics when a single person is presented within the image, but may be ill-equipped, for instance, when multiple (and varied numbers of) persons are included in the image, in some cases being forced to repeat the processing pipeline in a serial manner to complete the processing pipeline for each person appearing in the image, among other examples. Such an approach, however, may violate SLA terms (e.g., end-to-end latency), among other example issues.

Architectures of modern edge processing software may follow the microservices framework, where services or microservices (e.g., each programmed to perform a particular task or sub-function) are chained to achieve a complete function for an end-to-end service. In an end-to-end application processing context, the higher the service requirement, the larger the resource allocation needed to effectively implement the application. As such, for a larger application, the resource demands may overwhelm the resources of an individual edge computing system. Indeed, resources in edge systems are typically limited, although a distributed edge infrastructure may be utilized to combine resources to implement an application or service. In a distributed edge infrastructure, a set of decentralized nodes may be included, such as edge devices that are geographically dispersed, such as retail-edge servers, edge instances of cloud service providers, and edges systems of traditional network providers (e.g., 5G base stations and access points, etc.), among other examples. Edge infrastructure may be made available on demand, in some implementations, and may be leveraged to dynamically instantiate resources in response to the detected real-time needs of various applications.

In an improved edge computing infrastructure, the efficiency of end-to-end processing may be improved in an application-specific manner and tuned to the specific time and conditions of operation, for instance, by reducing latency, enhancing reliability, and optimizing resource utilization. For instance, an improved edge computing system may implement autonomous and dynamic service replication based on the functions and SLA of the application and characteristics of the respective input data to be operated upon by the service chain of the application. Service replication causes multiple instances of a given service or microservice to be instantiated on multiple edge systems. Service replication may provide higher processing resources across different nodes or locations within edge networks leveraging characteristics of distributed edge infrastructure.

As an example, an application may be developed to perform video processing to detect intrusion detection, where the speed of processing is important (e.g., to timely detect any intrusions) and where resources may be challenged during peak demand periods (e.g., during rush hour, periods, or days of high foot traffic, etc.). The improved edge computing infrastructure may dynamically identify opportunities to instantiate concurrent procedures in a processing pipeline for an application. For instance, an improved edge computing infrastructure may exploit dynamic service replication and segmentation capabilities based on characteristics of data to be processed in the pipeline, among other example features.

An improved edge computing infrastructure, such as discussed herein, may facilitate the adoption of real-time processing for critical applications like telehealth, industrial robotics, and fraud detection where real-time analytics is essential. Existing solutions typically rely on load-balancing a service through horizontal and vertical scaling of microservice instances based on the incoming demands and local resource utilization. For instance, existing technologies may rely on developer tools such as GStreamer and DLStreamer which require a developer to predict and pre-build any parallelization during development time and implement corresponding code, command-lines, or scripts to create a dedicated single processing pipeline used throughout the lifetime of the application. This approach puts the burden on the developers and IT management for the deployment of edge services on the edge infrastructures. In an improved edge computing infrastructure, the end-to-end application context of an application may be considered, with data to be consumed by the application being preprocessed based on the data type and type of analyses and operations to be performed being used as the basis for dynamically scaling the microservices relative to the data context through adaptive replication of services. Through such replication and/or segmentation, multiple, parallelized processing pipelines may be instantiated to exploit edge resource availability in distributed networks, the outputs of these multiple service instances being post-processed to combine the results to meet end-to-end service requirements.

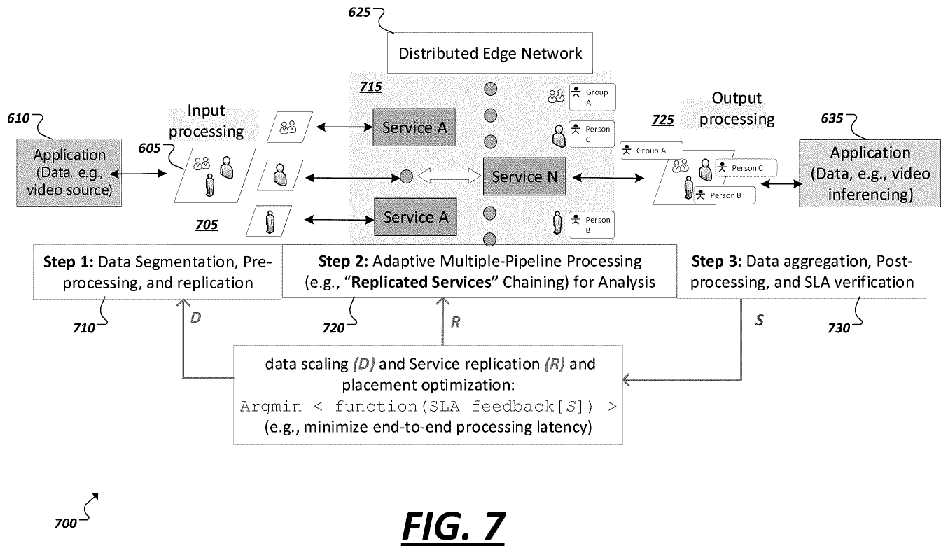

Turning to FIG. 7, a simplified block diagram 700 is shown of an example edge computing system to implement an end-to-end application utilizing a distributed edge network, where the edge computing devices include logic (e.g., implemented in hardware and/or software) to implement adaptive multi-pipeline processing (or replicated service chaining) to more effectively leverage the resources of the distributed edge network and increase the efficiency of the application's performance, including instances of complex input data (e.g., 605). In this example, the overall end-to-end application pipeline may be modified to include data scaling pre-processing 710 to dynamically parallelize the service chain 715 through adaptive mule-pipeline processing 720. A data aggregation stage 730 may also be included to aggregate and combine the component results of parallelized services to generate an expected output (e.g., for further processing by a next service in the chain or by another application (e.g., 635) which is to consume the application's 610 output. For instance, in one example, an application may be configured to identify particular persons in image or video data fed as an input to the application (e.g., for use in a security, retail analytics, or other application).

Input processing 705 of input data 605 may be performed (e.g., by one of the edge computing devices in the distributed edge network) in connection with the application to identify whether there are opportunities to replicate instances of and parallelize a next service in the service chain of the application. It may be expected that in several cases, the service or workload may be conveniently and effectively executed using a single edge computing device for certain types of data inputs. However, other data inputs to the service may reveal, through pre-processing of the data input, that an opportunity exists to replicate the service on one or more additional edge computing devices. For instance, in the case of image data and a service for performing image processing on the image data, the input processing may determine whether one or multiple persons appear in the data. In this example, multiple persons are identified as appearing in the image and the edge computing device responds by initiating the replication of the service that is to operate on the data (e.g., “Service A”) to create a number of parallel instances of the service corresponding with the number of persons' faces appearing in the data. Replicating the service may include identifying available candidate edge computing devices (e.g., within a similar geography within the distribute edge network) and instantiating these additional edge computing devices with instances of the service, as well as their respective portion of the input data. Each instance of the service can then operate on its respective portion of the data (e.g., corresponding to a respective one of the persons) to generate a respective output. As a next service in the application's service chain may expect to operate on input data of a particular format, the edge computing system may first aggregate the respective outputs of the multiple replicated instances of Service A to generate (at 725) a single combined output that incorporates the information in the replicated instances' outputs in the format expected by the next service in the chain.

Edge computing devices are typically resource constrained and distributed. Therefore, highly demanding applications to be implemented on an edge network typically involve dedicated planning, allocation, and a single heavyweight pipeline of execution to meet the demands of a given application. Typically, this heavyweight solution is engineered and retained for the lifetime of the application. An improved edge computing infrastructure, such as described herein, may alleviate the need for heavyweight, purpose-built solutions, through the use of highly-dynamic multiple processing pipelines exploiting the distributed nature of the edge infrastructure. Accordingly, through a pre-processing step, data may be assessed to determine opportunities to generate multiple pipelines processing stages (corresponding to a single or multiple services or functions within the application), with the outputs of these parallelized pipelines being post-processed to combine the results and preserve end-to-end context, among other example features.

In one implementation, application and service management may be edge-native and configured to support critical application requirements such as large compute on the data with dedicated end-to-end Service Level Agreements (SLA). Service configuration may be provided to end users through dedicated interfaces (e.g., to define end-to-end SLA, security requirements, etc. for an application). In some implementations, a developer framework or kit may be defined and provided to assist developers in developing applications that might utilize the dynamic processing pipeline creation, among other example tools. Consumable interfaces for middleware integration (e.g., intermediate services) can be independently replicated in the intermediate stages of execution (e.g., where the SLA between stage A to Stage N or service A through service N can be achieved).

An improved edge computing system may enable flexible and opportunistic scalability with the ability to dynamically increase or decrease processing capacities through the decomposition of services which can placed over a network of distributed edge nodes (e.g., within a particular geographic location or boundary) to implement an independent processing pipeline. In such a system, a pool of compute resources may not need to be pre-defined or pre-orchestrated for an end-to-end application with the improved system allowing a service function chain to create an independent processing pipeline over an independent path of distributed edge compute nodes. To achieve such flexibility, in some implementations, the system may define and implement data tagging (e.g., time stamping, sequencing, service instance stamping, etc.) or other meta data to synchronize the output and inputs of multiple processing pipelines created through opportunistic service replication provided by the improved edge computing system. Such metadata may be used, for instance, to post-process the data in a consistent and organized manner to ensure the successful regeneration of the output in the expected format for the next service in the service chain or as the final output of the application itself, among other examples.

An edge computing system may include logic (e.g., implemented in hardware and/or software) to implement dynamic replication of services within an end-to-end application. To determine an opportunity to replicate services, an edge computing system may identify the type of service (e.g., the operations or functions to be implemented in the service) as well as the input data to the service. The edge computing system may support a variety of replication strategies as such replication strategies and techniques may vary based on the changing environment, data type, or end-to-end characteristics (e.g., relative demand (e.g., rush hour as opposed to empty captures), changing network conditions, analysis-load levels, and user-defined conditions to ensure end-to-end service quality, among other examples. To determine whether a replication opportunity exists and what replication strategies may be applied, the data may be pre-processed to detect attributes of the data and identify opportunities, relative to the type of service, to replicate the service and parallelize tasks to be performed on the data by the service. To determine the replication strategy to be implemented, data pre-processing may be performed utilizing a centralized or localized approach and/or a distributed approach. In some cases, machine learning may be utilized to perform the pre-processing (e.g., using reinforcement learning, deep learning, or other techniques). In some implementations, a service replication strategy may include a data segmentation step, where multiple portions of a piece of data may be identified. The replication may involve replicating a given service such that each replicated instance of the service operates on a respective one of the identified portions of the piece of data. Accordingly, in some instances, data may be segmented to create a unique processing pipeline, such as looking only at group or collection of features, selecting a specific feature set, or working on a background to facilitate the auxiliary information to the overall analysis, among other examples.

An edge computing system may include logic (e.g., implemented in hardware and/or software) to implement dynamic replication of services within an end-to-end application. To determine an opportunity to replicate services, an edge computing system may identify the type of service (e.g., the operations or functions to be implemented in the service) as well as the input data to the service. The edge computing system may support a variety of replication strategies as such replication strategies and techniques may vary based on the changing environment, data type, or end-to-end characteristics (e.g., relative demand (e.g., rush hour as opposed to empty captures), changing network conditions, analysis-load levels, and user-defined conditions to ensure end-to-end service quality, among other examples. To determine whether a replication opportunity exists and what replication strategies may be applied, the data may be pre-processed to detect attributes of the data and identify opportunities, relative to the type of service, to replicate the service and parallelize tasks to be performed on the data by the service. To determine the replication strategy to be implemented, data pre-processing may be performed utilizing a centralized or localized approach and/or a distributed approach. In some cases, machine learning may be utilized to perform the pre-processing (e.g., using reinforcement learning, deep learning, or other techniques). In some implementations, a service replication strategy may include a data segmentation step, where multiple portions of a piece of data may be identified. The replication may involve replicating a given service such that each replicated instance of the service operates on a respective one of the identified portions of the piece of data. Accordingly, in some instances, data may be segmented to create a unique processing pipeline, such as looking only at group or collection of features, selecting a specific feature set, or working on a background to facilitate the auxiliary information to the overall analysis, among other examples.

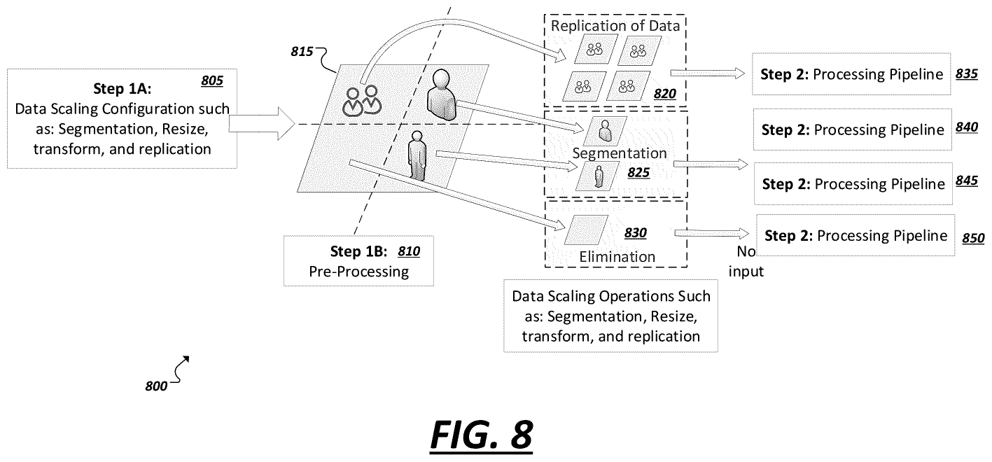

Turning to FIG. 8, a simplified block diagram 800 is shown illustrating the example pre-processing and data scaling to be performed in an example edge deployment of an application. Data scaling and preprocessing may include a variety of operations based on the type of data and the services in the service chain (e.g., to align the data scaling with opportunities to parallelize the service chain). For instance, preprocessing 810 of input data (e.g., 815) may be based on a configuration 805 defined for the application based on the operations that are to be performed on the data by the services in the application and the expected or defined output format for results generated by the application. The configuration 805 may also define how the pre-processing and analysis of the inputs data is to be performed (e.g., what algorithms or tools are to be used, whether locally or with the assistance of a remote (e.g., cloud-based) resource, etc.) and under what conditions service replication should take place (and for which services in the service chain). In one example, data scaling may include segmentation, replication, scaling, and elimination. In the case of segmentation (e.g., 825), preprocessing of the data may include identifying portions of a single piece of data (e.g., image, video, audio, text, database, etc.), which represent distinct entities or representations of information that are to be the subject of operations in a given service or collection of services in the processing pipeline. In some instances, segmentation 825 of the data may allow for service replication to operate on each identified segment of the data. In the case of data replication (e.g., 820), characteristics of the input data may allow for the data to be replicated and input into multiple distinct services in a parallel, where each service performs a respective operation on its copy of the data (e.g., one service identifying the gender of a face pictured in an image, another service identifying the age range of a face pictured in an image, etc.). For elimination (e.g., 830), portions of the data which include useless, confusing, or irrelevant information may be identified during pre-processing 810, and may allow these portions to be represented as null inputs to a respective processing pipeline (e.g., 850) in a set of parallelized pipelines (e.g., 835, 840, 845, 850) generated based on the pre-processing. Opportunities to scale, resize, and otherwise transform all or particular portions of the data 815 may be identified through pre-processing (e.g., to crop the data to focus on a portion (e.g., a face, voice sample, etc.) that is to be focused on in a subsequent pre-processing step). Preprocessing 810 may identify opportunities to both replicate services in the service chain, as well as opportunities to make the processing of data segments by respective replicated service instances more efficient (e.g., in the case of data transformations or elimination), among other examples.

Where a service is replicated, each instance of the service may generate a respective output from the portion of the data operated upon by the service instance. To generate a complete output, in some instances, the respective outputs of the set of service instances may be combined to form a single, unitary output that captures the aggregated outputs of the multiple service instances. One of the edge computing systems used to execute one of the replicated service instances may further include logic (e.g., implemented in hardware and/or software) to aggregate the outputs of the replicated service instances and generate a combined or aggregate output for the service and pass this output as the input to a next service within the end-to-end application or, alternatively, as the final output of the end-to-end application (e.g., where the replicated service is the final service within a chain of services implementing the end-to-end application. In order to facilitate the aggregation of the outputs of a replicated service, metadata or other tools may be used to maintain consistency and synchronization between the replicated service instances. In one example, data is tagged and maintained with consistency among replicated instances by implementing appropriate synchronization mechanisms to ensure that data remains coherent across replicas, among other example implementations.

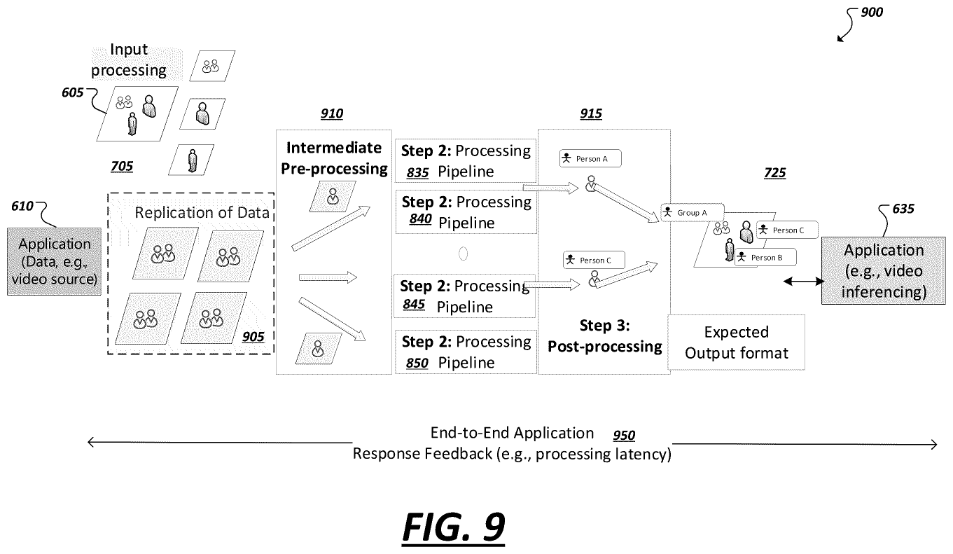

In some implementations, multiple pre-processing stages and multiple service replication stages may be utilized in the implementation of an end-to-end application using a distributed edge network. In some instances, multiple data scaling operations may be performed in connection with a common pre-processing step for a service in a service chain. In some cases, data scaling operations may be nested. For instance, FIG. 9 is a simplified block diagram 900 illustrating the use of multiple processing pipelines through the replication of one or more services in a service chain of an end-to-end application (e.g., 950). An application or other data source (e.g., 610) may provide data 705 for processing by the application 950. One of the services in the service chain may be performed by a particular one of potentially multiple edge computing devices in an edge cloud or other edge system. The particular edge computing device may determine 705 (e.g., from characteristics of the service and/or data) that opportunities exist to instantiate multiple processing pipelines by replicating the service across multiple edge computing devices in parallel. In this example, the particular edge computing device may determine that the data 605 and service would benefit from the selection of a particular segment 920 of the data and the replication 905 of this particular section of data (e.g., to run the segment 920 through multiple tasks or algorithms to be performed on the input using multiple replicated instances of the service (with each replicated instance performing only one or some other subset of the set of algorithms of the service) in order to meet or exceed a particular service level or performance objective specified for the application 950). In this example, a nested preprocessing may further involve identifying, among each replicated segment of the data, that intermediate preprocessing 910 may be performed to further segment the data 705 and dynamically parallelize the service. For instance, each of the segments of data 920 may imagery of multiple persons or parts that are subject to further processing on a person- or part-basis and each replicated segment 920 may be further segmented (at 910) to isolate the image of the individual part, person, or other entity for processing in a respective parallel processing pipeline (e.g., 835, 840, 845, 850, etc.).

The particular edge computing device performing these pre-processing steps may determine, based on the results of the pre-processing, that a number of parallel processing pipelines should be establish based on the segmentation and/or replication performed during the pre-processing and work to instantiate a corresponding number of replicated instances of the service that are to perform work on each respective segment and/or copy from the original data (e.g., 605) input to the service. Additionally, the particular edge computing device may additionally manage the collection of results from the multiple replicated service instances and perform post processing 915 to generate a combined or aggregate result 725 in the format expected by the next service in the application or service chain or other consumer (e.g., application 635) of the service's result.

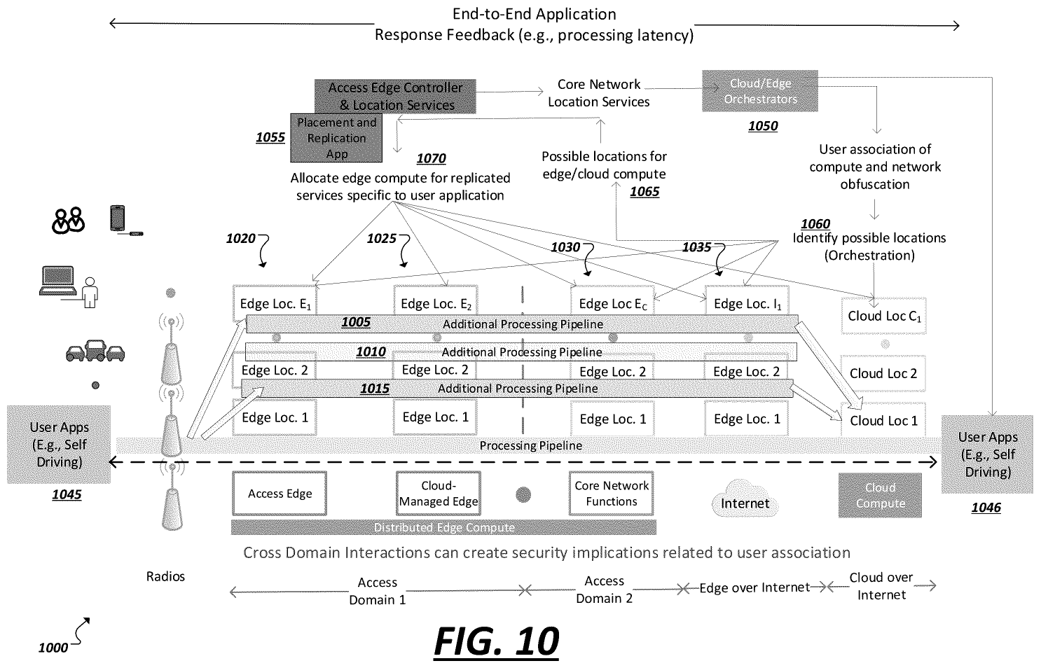

Turning to FIG. 10, a simplified block diagram 1000 is shown illustrating another example of a system capable of implementing an end-to-end application and leveraging dynamic parallelization of processing pipelines in the execution. As in other examples, the input data (e.g., from 1045) is analyzed for possible parallelization of workload, specific to end-to-end context. User applications (e.g., 1045, 1046), inclusive of both client and cloud applications, can interact with orchestrators (e.g., 1050) in the cloud and/or edge system to indicate various end-to-end QoS service requirements, permissions, and configurations for the application to drive decisions made during pre-processing to identify whether and what data scaling is allowed or should be performed and what, if any limitations, are to govern how services are replicated and parallel processing pipelines are initiated in the execution of the application. Additionally, such configuration information may also be used to direct the monitoring of the setup and performance of the application (and the edge devices used to execute portions of the application), as well as set up telemetry services, among other examples. The policies for the data pre-processing may be generated based on the learning mechanism to identify the independent tasks that can be serialized to achieve an independent processing pipeline. The creation of processing pipeline may be tied to a data processing logic such that there is dedicated input and output pair for each processing pipeline. The number of processing pipelines may be created and destroyed based on the close loop control or, in some implementations, through the use of reinforcement learning with feedback.

In the example of FIG. 10, the configuration parameters of the applications 1045 and 1046 and the characteristics of the data input to application 1045 may be the basis for pre-processing of the data and determining that replication of one or more service in the application is to be performed (e.g., with each of the replicated services charged with operating on a particular segment or copy of the data as determined during preprocessing). Accordingly, multiple processing pipelines (e.g., 1005, 1010, 1015) may be established. In some cases, multiple stages of multiple processing pipelines may be established, with two or more services in the application service chain being replicated (e.g., with the same or different number of replicated instances and processing pipelines) based on the nature of the service and the data being operated on by the service (which may be based on the output of a preceding service in the service chain). Where services are replicated, additional edge computing devices at the same or different geographical locations may be provisioned to handle a respective replicated instance of a service. Accordingly, groups of edge computing devices (e.g., 1020, 1025, 1030, 1035, etc.) may be provisioned to implement respective parallel processing pipelines (e.g., 1005, 1010, 1015). When provisioning additional edge computing devices for use in handling replicated service instances, an edge controller and location services system (e.g., 1054) may be utilized to identify 1060 available edge computing devices based on their location (e.g., within a particular geographic proximity of the edge computing device tasked with performing the service and potentially also handling pre- and post-processing associated with dynamic parallelization of the service) and possessing the requisite hardware or functionality to execute an instance of the particular service to be replicated. This information may be passed (e.g., at 1065) to placement and replication logic 1055 (e.g., a program run on the edge computing device performing the pre-processing or another edge or cloud system resource) and used to allocate (e.g., 1070) edge compute for replicated services for the application.

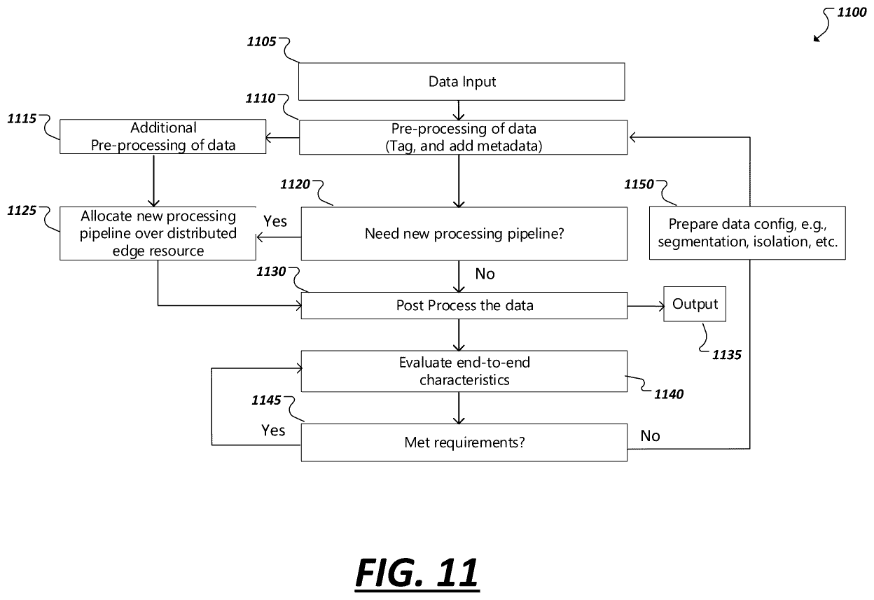

Turning to FIG. 11, a simplified flow diagram 1100 is shown illustrating an example technique for opportunistically and dynamically replicating services within an end-to-end cloud application. Data may be accessed (e.g., received) by an edge computing device that is to perform a service or task in an end-to-end application to be implemented in an edge cloud. The data may be preprocessed 1110 to identify opportunities to scale the data in some manner based on characteristics of the data detected or inferred from the preprocessing (e.g., detecting certain entities, characteristics, or patterns within the input data). In some cases, multiple stages of preprocessing may be performed 1115 (e.g., multiple stages of segmentation of the data, replicating followed by segmentation, segmentation followed by replication, etc.). Based on the preprocessing, opportunities may be determined (at 1120) for replicating the service and processing the data using the edge computing device and one or more additional edge computing devices. The new processing pipelines may be allocated 1125 using one or more available and qualified (e.g., based on geography and/or functionality) edge computing resources. In cases where multiple processing pipelines have been created, post processing 1130 may be performed to combine the respective outputs generated by the replicated services instances executed by the multiple edge computing devices to generate a unitary or aggregate output 1135 in the expected format. The use of the multiple parallel processing pipelines may be monitored, for instance, by an orchestrator or other utility of the edge deployment to evaluate 1140 characteristics of the end-to-end application's execution. Feedback data may be generated based on (1145) whether requirements or SLAs of the application were met or not, or even exceeded, based on the use of the multiple processing pipelines that were dynamically adopted during execution of the service. This information may be utilized (e.g., at 1150) in connection with future pre-processing (e.g., 1110) of data in association with future instances of the service, as well as future determinations of whether to launch multiple processing pipelines in association with the service to improve the use of such dynamically replicated services instances in future executions by the system, among other example uses.

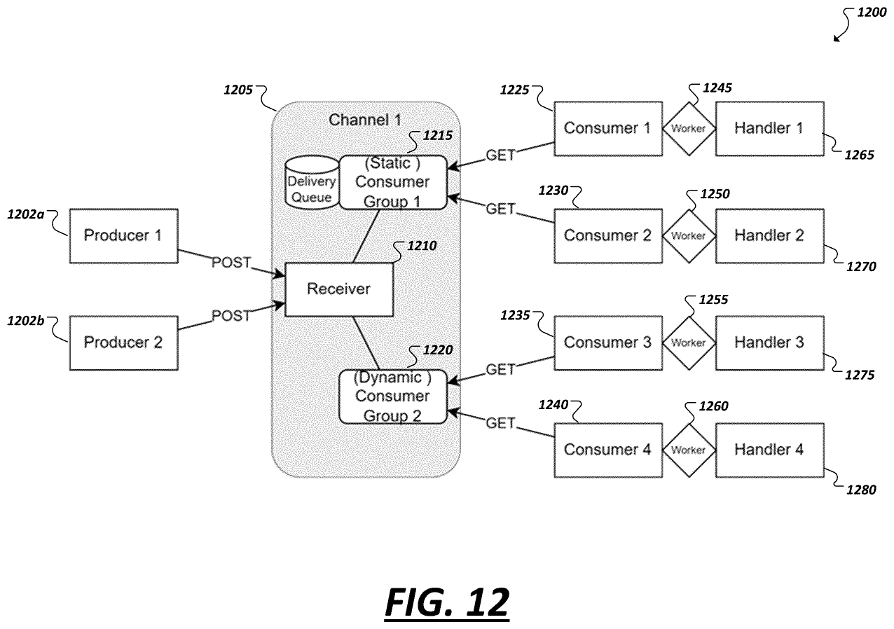

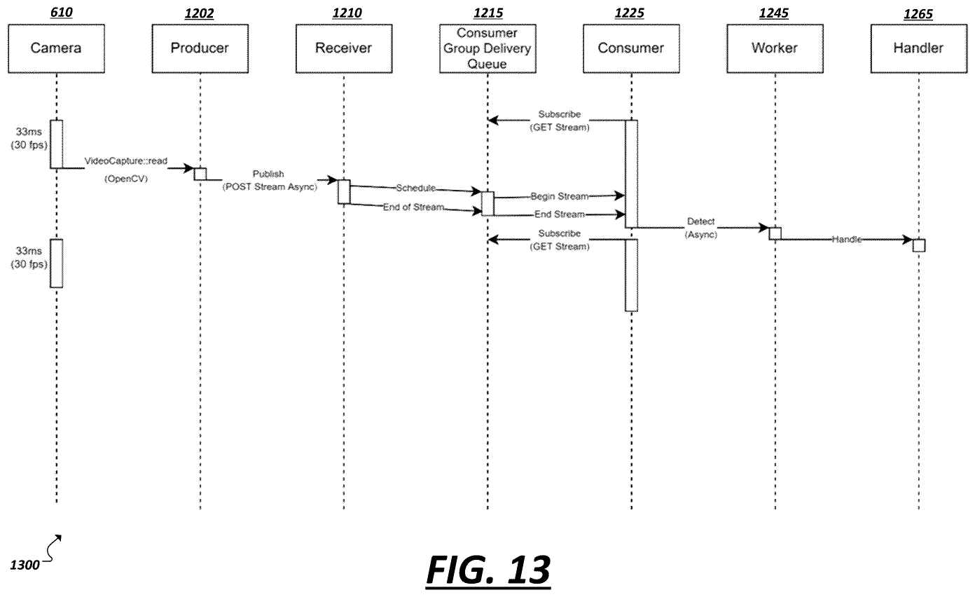

In the instantiation of multiple replicated service instances, input data may be distributed and shared with the other edge devices allocated with logic to perform the replicated service instances. FIG. 12 is a simplified block diagram illustrating an example software architecture for facilitating such data distribution. In some instances, the data pipeline data structures are the data plane of the edge system discussed herein. The data pipeline may facilitate the flow of messages from a producer (e.g., 1202a-b), or source of the input data, to distribute appropriate data to worker processes (e.g., 1245, 1250, 1255, 1260) responsible for processing the data in association with the logic of the associated service. In some implementations, the distribution of the data may be according to a publish-subscribe model. For instance, each pipeline service instance may have all of the code or logic to execute all of these data structures, but the control configuration instructs each instance which processes it should utilize. For instance, the input data may be posted to a receiver 1210 (e.g., on a particular edge computing resource) and pre-processing of the data may result in different groupings (e.g., 1215, 1220) being identified to correspond to different segments or copies determined for the data based on the pre-processing. In association with the allocation of multiple processing pipelines to handle these data groupings, respective consumer entities (e.g., 1225, 1230, 1235, 1240) may fetch their respective data (e.g., generated during the preprocessing) and pass to associated worker elements (e.g., 1245, 1250, 1255, 1260), which may utilize associated handlers (e.g., 1265, 1270, 1275, 1280) to provide and manage the respective system resources for operating on the data. FIG. 13 illustrates an example flow and messaging in distributing data (e.g., generated by a camera data source 610) from the producer (e.g., 1202) through to the worker 1245 and handler 1265 in accordance with one example implementation.

In some implementations, control plane data structures may be provided to facilitate remote procedure calls to processes via a centralized mechanism. These remote procedure calls may include commands for control, configuration, telemetry, and notifications. In one example, the interface uses HTTP web protocols and may be implemented using WebSockets and an ASP.NET SignalR Core to leverage the associated rich capabilities, high performance, scalability, and community support. Such control plane data structures may include Control (Start, Stop, Restart, Ping), Configuration (Apply Settings), Telemetry (Logging, Monitoring, Observability), Notifications (Process Online, Process Offline, Process Error), among other examples.

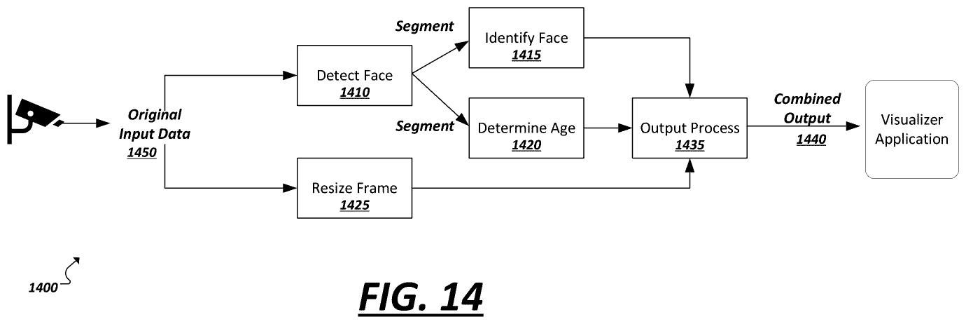

FIG. 14 is a simplified flow diagram illustrating the example replication of a service. For instance, in one example application, a full-frame image from a camera feed may be replicated across one or more multiple stages in a service-chained-function (e.g., at the direction of one of the edge-based service nodes). Replica service nodes may be allocated and distributed portions of the data for transmitted to dynamically scale the service based, for instance, on the needs of an end-to-end application-inferencing, quality and accuracy of results, adapting to the network-availability, or resource availability to achieve end-to-end characteristics (e.g., latency and workload requirements). In the example of FIG. 14, an example pipeline for face recognition processing is shown. The pipeline may take, as an initial input, image data 1405 from a camera within an environment (e.g., within close geographic proximity of an edge cloud called upon to implement the pipeline). Some of the services may include a detect faces service 1410, which may take as an input the full-size image from the camera and find one or more distinct faces represented in the image. A facial landmarks/facial identifier service 1415 may also be provided, which may run two sequential inferences on each face detected in the image (e.g., by the detect faces service 1410) to identify facial landmarks and identify the face based on these landmarks. An age attribute service 1420 may also be included in the pipeline, which may take a single face image and infer the age of the person behind the face. Additionally, a resize frame service 1425 may be provided that takes a full-size image from the camera and resizes it (e.g., to minimize network utilization for a visualizer program 1430, which is to receive and consume the output of the pipeline).

Continuing with the example of FIG. 14, in this example image processing pipeline, the minimum end-to-end processing is an image which includes no faces. In such an instance, the full-frame image is transmitted twice: once to fetch from the camera, and once to transmit to the detect faces service 1410. The output in this case would be a resized version of the image (as generated by the resize frame service 1425) which is transmitted to the visualizer application 1430. On the other hand, the maximum end-to-end processing involves an input image that includes multiple faces. The full-frame image is transmitted twice: Once to fetch from the camera, and once to transmit to the detect faces service 1410. Dynamic service replication may be deployed in this instance, with the image being segmented to correspond to each identified face and a replication of the identify face service and determine age service being instantiated for each identified face segment. With each face being transmitted to potentially multiple worker instances of these services (e.g., 1415, 1420), a high degree of parallelism is achieved, but at the expense of network utilization (e.g., to transmit each of the face images. These and other factors may be monitored by the system, with performance telemetry collected so as to optimizing the allocation of workers based on number of faces versus inferencing compute utilization, among other example features. The results of the parallel service replicas may be combined to form a single unitary output for each service (e.g., 1410, 1415, 1420) and this information may be combined (e.g., as metadata describing the inferred attributes of the various faces within the image) with a resized image (generated by the resize frame service 1425) to be transmitted to the consuming entity (e.g., visualizer application 1430), among a variety of other examples. Indeed, while some of the examples have utilized image data and image processing, computer vision, and other image-related pipelines, it should be appreciated that such dynamic service replication within edge computing environments may be applied to a potentially limitless variety of other pipelines, services, applications, and data.

“Logic”, as used herein, may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software-based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 418A0 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, e.g., reset, while an updated value potentially includes a low logical value, e.g., set. Note that any combination of values may be utilized to represent any number of states.

The embodiments of methods, hardware, software, firmware, or code set forth above may be implemented via instructions or code stored on a machine-accessible, machine readable, computer accessible, or computer readable medium which are executable by a processing element. A non-transitory machine-accessible/readable medium includes any mechanism that provides (e.g., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is a non-transitory machine-readable storage medium with instructions stored thereon, the instructions executable to cause a machine to: receive data to be processed in an application, where the application includes a set of services, at least a particular one of the set of services is to be executed on a first edge computing device, and the particular service is to perform a set of operations on the data; analyze the data to determine characteristics of the data; determine an opportunity to replicate the particular service on a plurality of edge computing devices based on characteristics of the data; determine that a second edge computing device is available to execute a replicated instance of the particular service, where the plurality of edge computing devices is to include the first edge computing device and the second edge computing device; and initiate replication of the particular service on the plurality of edge computing devices, where an output of an instance of the particular service executed on the first edge computing device and an output of the replicated instance of the particular service executed on the second edge computing device are to be combined to form a single output for the particular service.

Example 2 includes the subject matter of example 1, where the opportunity to replicate the particular service is further determined based on attributes of the set of operations of the particular service.

Example 3 includes the subject matter of any one of examples 1-2, where the opportunity to replicate the particular service is further determined based on performance metrics defined for the application.

Example 4 includes the subject matter of any one of examples 1-3, where the determination of whether or not to replicate the particular service is determined dynamically based at least in part on the characteristics of the data.

Example 5 includes the subject matter of any one of examples 1-4, where the instructions are further executable to: generate copies of the data based on the opportunity; and pass respective copies of the data to the plurality of edge computing devices to execute in instances of the particular service.

Example 6 includes the subject matter of any one of examples 1-5, where the instructions are further executable to: determine a plurality of segments of the data based on the characteristics of the data; and pass a respective segment of the data to the to the plurality of edge computing devices to execute in instances of the particular service.

Example 7 includes the subject matter of example 6, where the opportunity is based on the set of operations being performed separately for each of the plurality of segments.

Example 8 includes the subject matter of example 7, where the data includes image data, the set of operations include image processing operations to be performed on a depiction of person or thing in the image data, a plurality of distinct persons or things are identified in the image data through analysis of the data, and the plurality segments correspond to depictions of the plurality of distinct persons or things in the image data.

Example 9 includes the subject matter of any one of examples 1-8, where the instructions are further executable to: receive second data to be operated upon by the set of operations in a second execution of the particular service; analyze the second data to determine characteristics of the second data; and determine that no opportunities exist to replicate the particular service in the second execution of the particular service based on the characteristics of the second data.

Example 10 includes the subject matter of any one of examples 1-9, where the data is analyzed using a machine learning algorithm to determine a distinct persons, things, or entities described in the data, where the characteristics of the data correspond to the distinct persons, things, or entities described in the data.

Example 11 includes the subject matter of any one of examples 1-10, where the instructions are further executable to: generate the single output for the particular service from the output of the instance of the particular service executed on the first edge computing device and the output of the replicated instance of the particular service executed on the second edge computing device.

Example 12 includes the subject matter of example 11, where an expected format is defined for the output of the particular service and the single output is generated in the expected format.

Example 13 includes the subject matter of example 12, where at least one of the output of the instance of the particular service executed on the first edge computing device or the output of the replicated instance of the particular service executed on the second edge computing device is not in the expected format.

Example 14 includes the subject matter of example 12, where the single output is to be provided as an input to another service in the application or as an output of the application.

Example 15 is an apparatus including: an edge computing device including: a processor; a memory; a network adapter to couple to a network including a plurality of other edge computing devices; an orchestrator, executable by the processor to: receive a particular workload in an application, where the workload includes one of a plurality of workloads to executed in the application; and cause the particular workload to be executed by the edge computing device; and a service replication manager, executable by the processor to: identify attributes of data to be processed in the particular workload; determine an opportunity to replicate the particular workload on one or more of the plurality of other edge computing devices based on the attributes of the data; determine that a particular one of the plurality of other edge computing devices is available to execute a replicated instance of the particular workload; initiate replication of the particular workload on the particular other edge computing device; and generate a combined output for the particular workload based on an output from execution of the particular workload by the edge computing device and an output from execution of the replicated instances of the particular workload.

Example 16 includes the subject matter of example 15, where the service replication manager is to identify a plurality of segments of the data, a first one of the plurality of segments is to be processed in the execution of the particular workload by the edge computing device, and a second one of the plurality of segments is to be processed in the execution of the replicated instance of the particular workload by the particular other edge computing device.

Example 17 includes the subject matter of any one of examples 15-16, where the execution of the particular workload by the edge computing device and the execution of the replicated instance of the particular workload by the particular other edge computing device is at least partially in parallel.

Example 18 includes the subject matter of any one of examples 15-17, where the opportunity to replicate the particular service is further determined based on attributes of the set of operations of the particular service.

Example 19 includes the subject matter of any one of examples 15-18, where the opportunity to replicate the particular service is further determined based on performance metrics defined for the application.

Example 20 includes the subject matter of any one of examples 15-19, where the determination of whether or not to replicate the particular service is determined dynamically based at least in part on the characteristics of the data.

Example 21 includes the subject matter of any one of examples 15-20, where the service replication manager is further executable to: generate copies of the data based on the opportunity; and pass respective copies of the data to the plurality of edge computing devices to execute in instances of the particular service.

Example 22 includes the subject matter of any one of examples 15-21, where the service replication manager is further executable to: receive second data to be operated upon by the set of operations in a second execution of the particular service; analyze the second data to determine characteristics of the second data; and determine that no opportunities exist to replicate the particular service in the second execution of the particular service based on the characteristics of the second data.

Example 23 includes the subject matter of any one of examples 15-22, where the data is analyzed using a machine learning algorithm to determine a distinct persons, things, or entities described in the data, where the characteristics of the data correspond to the distinct persons, things, or entities described in the data.

Example 24 includes the subject matter of any one of examples 15-23, where the service replication manager is further executable to: generate the single output for the particular service from the output of the instance of the particular service executed on the first edge computing device and the output of the replicated instance of the particular service executed on the second edge computing device.

Example 25 includes the subject matter of example 24, where an expected format is defined for the output of the particular service and the single output is generated in the expected format.

Example 26 includes the subject matter of example 25, where at least one of the output of the instance of the particular service executed on the first edge computing device or the output of the replicated instance of the particular service executed on the second edge computing device is not in the expected format.

Example 27 includes the subject matter of example 25, where the single output is to be provided as an input to another service in the application or as an output of the application.

Example 28 is a system including: a first edge computing device; a second edge computing device coupled to the first edge computing device in a network; and an edge orchestrator, executable by a processor to: orchestrate execution of an application, where the application includes a chain of services; and cause a service in the chain of services to be executed by the first edge computing device; where the first edge computing device is to: receive data to be processed in the service; analyze the data to determine characteristics of the data; determine an opportunity to replicate the service to form multiple processing pipelines for the data based on the characteristics of the data; perform data scaling on the data based on the opportunity; initiate replication of the service on the second edge computing device based on the data scaling; and generate a combined output for the service based on an output from execution of the service by the edge computing device and an output from execution of the replicated instances of the service by the second edge computing device.

Example 29 includes the subject matter of example 28, where data scaling includes at least one of replication of the data, segmentation of the data, elimination of at least a portion of the data, or performing a data transform on the data.

Example 30 includes the subject matter of any one of examples 28-29, where the second edge computing device is selected to execute a replicated instance of the service based on one or more of availability of the second edge computing device, geographic location of the second edge computing device, or hardware features of the second edge computing device.

Example 31 includes the subject matter of any one of examples 28-30, where the opportunity to replicate the particular service is further determined based on attributes of the set of operations of the particular service.

Example 32 includes the subject matter of any one of examples 28-31, where the opportunity to replicate the particular service is further determined based on performance metrics defined for the application.

Example 33 includes the subject matter of any one of examples 28-32, where the determination of whether or not to replicate the particular service is determined dynamically based at least in part on the characteristics of the data.

Example 34 includes the subject matter of any one of examples 28-33, where first edge computing device is further to: generate copies of the data based on the opportunity; and pass respective copies of the data to the plurality of edge computing devices to execute in instances of the particular service.

Example 35 includes the subject matter of any one of examples 28-34, where first edge computing device is further to: determine a plurality of segments of the data based on the characteristics of the data; and pass a respective segment of the data to the to the plurality of edge computing devices to execute in instances of the particular service.

Example 36 includes the subject matter of example 35, where the opportunity is based on the set of operations being performed separately for each of the plurality of segments.

Example 37 includes the subject matter of example 36, where the data includes image data, the set of operations include image processing operations to be performed on a depiction of person or thing in the image data, a plurality of distinct persons or things are identified in the image data through analysis of the data, and the plurality segments correspond to depictions of the plurality of distinct persons or things in the image data.

Example 38 includes the subject matter of any one of examples 28-37, where first edge computing device is further to: receive second data to be operated upon by the set of operations in a second execution of the particular service; analyze the second data to determine characteristics of the second data; and determine that no opportunities exist to replicate the particular service in the second execution of the particular service based on the characteristics of the second data.

Example 39 includes the subject matter of any one of examples 28-38, where the data is analyzed using a machine learning algorithm to determine a distinct persons, things, or entities described in the data, where the characteristics of the data correspond to the distinct persons, things, or entities described in the data.

Example 40 includes the subject matter of any one of examples 28-39, where first edge computing device is further to: generate the single output for the particular service from the output of the instance of the particular service executed on the first edge computing device and the output of the replicated instance of the particular service executed on the second edge computing device.

Example 41 includes the subject matter of example 40, where an expected format is defined for the output of the particular service and the single output is generated in the expected format.

Example 42 includes the subject matter of example 41, where at least one of the output of the instance of the particular service executed on the first edge computing device or the output of the replicated instance of the particular service executed on the second edge computing device is not in the expected format.

Example 43 includes the subject matter of example 41, where the single output is to be provided as an input to another service in the application or as an output of the application.

Example 44 is a method including: receiving data to be processed in an application, where the application includes a set of services, at least a particular one of the set of services is to be executed on a first edge computing device, and the particular service is to perform a set of operations on the data; analyzing the data to determine characteristics of the data; determining an opportunity to replicate the particular service on a plurality of edge computing devices based on characteristics of the data; determining that a second edge computing device is available to execute a replicated instance of the particular service, where the plurality of edge computing devices is to include the first edge computing device and the second edge computing device; and initiating replication of the particular service on the plurality of edge computing devices, where an output of an instance of the particular service executed on the first edge computing device and an output of the replicated instance of the particular service executed on the second edge computing device are to be combined to form a single output for the particular service.

Example 45 includes the subject matter of example 44, where the opportunity to replicate the particular service is further determined based on attributes of the set of operations of the particular service.

Example 46 includes the subject matter of any one of examples 44-45, where the opportunity to replicate the particular service is further determined based on performance metrics defined for the application.

Example 47 includes the subject matter of any one of examples 44-46, where the determination of whether or not to replicate the particular service is determined dynamically based at least in part on the characteristics of the data.

Example 48 includes the subject matter of any one of examples 44-47, further including: generating copies of the data based on the opportunity; and passing respective copies of the data to the plurality of edge computing devices to execute in instances of the particular service.

Example 49 includes the subject matter of any one of examples 44-48, further including: determining a plurality of segments of the data based on the characteristics of the data; and passing a respective segment of the data to the to the plurality of edge computing devices to execute in instances of the particular service.

Example 50 includes the subject matter of example 49, where the opportunity is based on the set of operations being performed separately for each of the plurality of segments.

Example 51 includes the subject matter of example 50, where the data includes image data, the set of operations include image processing operations to be performed on a depiction of person or thing in the image data, a plurality of distinct persons or things are identified in the image data through analysis of the data, and the plurality segments correspond to depictions of the plurality of distinct persons or things in the image data.

Example 52 includes the subject matter of any one of examples 44-51, further including: receiving second data to be operated upon by the set of operations in a second execution of the particular service; analyzing the second data to determine characteristics of the second data; and determining that no opportunities exist to replicate the particular service in the second execution of the particular service based on the characteristics of the second data.

Example 53 includes the subject matter of any one of examples 44-52, where the data is analyzed using a machine learning algorithm to determine a distinct persons, things, or entities described in the data, where the characteristics of the data correspond to the distinct persons, things, or entities described in the data.

Example 54 includes the subject matter of any one of examples 44-53, further including: generating the single output for the particular service from the output of the instance of the particular service executed on the first edge computing device and the output of the replicated instance of the particular service executed on the second edge computing device.

Example 55 includes the subject matter of example 54, where an expected format is defined for the output of the particular service and the single output is generated in the expected format.

Example 56 includes the subject matter of example 55, where at least one of the output of the instance of the particular service executed on the first edge computing device or the output of the replicated instance of the particular service executed on the second edge computing device is not in the expected format.

Example 57 includes the subject matter of example 55, where the single output is to be provided as an input to another service in the application or as an output of the application.

Example 58 is a system including means to perform the method of any one of examples 44-57.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. At least one non-transitory machine-readable storage medium with instructions stored thereon, the instructions executable to cause a machine to:
receive data to be processed in an application, wherein the application comprises a set of services, at least a particular one of the set of services is to be executed on a first edge computing device, and the particular service is to perform a set of operations on the data;
analyze the data to determine characteristics of the data;
determine an opportunity to replicate the particular service on a plurality of edge computing devices based on characteristics of the data;
determine that a second edge computing device is available to execute a replicated instance of the particular service, wherein the plurality of edge computing devices is to comprise the first edge computing device and the second edge computing device; and
initiate replication of the particular service on the plurality of edge computing devices, wherein an output of an instance of the particular service executed on the first edge computing device and an output of the replicated instance of the particular service executed on the second edge computing device are to be combined to form a single output for the particular service.

2. The storage medium of claim 1, wherein the opportunity to replicate the particular service is further determined based on attributes of the set of operations of the particular service.

3. The storage medium of claim 1, wherein the opportunity to replicate the particular service is further determined based on performance metrics defined for the application.

4. The storage medium of claim 1, wherein the determination of whether or not to replicate the particular service is determined dynamically based at least in part on the characteristics of the data.

5. The storage medium of claim 1, wherein the instructions are further executable to:
generate copies of the data based on the opportunity; and
pass respective copies of the data to the plurality of edge computing devices to execute in instances of the particular service.

6. The storage medium of claim 1, wherein the instructions are further executable to:
determine a plurality of segments of the data based on the characteristics of the data; and
pass a respective segment of the data to the to the plurality of edge computing devices to execute in instances of the particular service.

7. The storage medium of claim 6, wherein the opportunity is based on the set of operations being performed separately for each of the plurality of segments.

8. The storage medium of claim 7, wherein the data comprises image data, the set of operations comprise image processing operations to be performed on a depiction of person or thing in the image data, a plurality of distinct persons or things are identified in the image data through analysis of the data, and the plurality segments correspond to depictions of the plurality of distinct persons or things in the image data.

9. The storage medium of claim 1, wherein the instructions are further executable to:
receive second data to be operated upon by the set of operations in a second execution of the particular service;
analyze the second data to determine characteristics of the second data; and
determine that no opportunities exist to replicate the particular service in the second execution of the particular service based on the characteristics of the second data.

10. The storage medium of claim 1, wherein the data is analyzed using a machine learning algorithm to determine a distinct persons, things, or entities described in the data, wherein the characteristics of the data correspond to the distinct persons, things, or entities described in the data.

11. The storage medium of claim 1, wherein the instructions are further executable to:
generate the single output for the particular service from the output of the instance of the particular service executed on the first edge computing device and the output of the replicated instance of the particular service executed on the second edge computing device.

12. The storage medium of claim 11, wherein an expected format is defined for the output of the particular service and the single output is generated in the expected format.

13. The storage medium of claim 12, wherein at least one of the output of the instance of the particular service executed on the first edge computing device or the output of the replicated instance of the particular service executed on the second edge computing device is not in the expected format.

14. The storage medium of claim 12, wherein the single output is to be provided as an input to another service in the application or as an output of the application.

15. An apparatus comprising:
an edge computing device comprising:
a processor;
a memory;
a network interface contoller to couple to a network comprising a plurality of other edge computing devices;
an orchestrator, executable by the processor to:
receive a particular workload in an application, wherein the workload comprises one of a plurality of workloads to executed in the application; and
cause the particular workload to be executed by the edge computing device; and
a service replication manager, executable by the processor to:
identify attributes of data to be processed in the particular workload;
determine an opportunity to replicate the particular workload on one or more of the plurality of other edge computing devices based on the attributes of the data;
determine that a particular one of the plurality of other edge computing devices is available to execute a replicated instance of the particular workload;
initiate replication of the particular workload on the particular other edge computing device; and
generate a combined output for the particular workload based on an output from execution of the particular workload by the edge computing device and an output from execution of the replicated instances of the particular workload.

16. The apparatus of claim 15, wherein the service replication manager is to identify a plurality of segments of the data, a first one of the plurality of segments is to be processed in the execution of the particular workload by the edge computing device, and a second one of the plurality of segments is to be processed in the execution of the replicated instance of the particular workload by the particular other edge computing device.

17. The apparatus of claim 15, wherein the execution of the particular workload by the edge computing device and the execution of the replicated instance of the particular workload by the particular other edge computing device is at least partially in parallel.

18. A system comprising:
a first edge computing device;
a second edge computing device coupled to the first edge computing device in a network; and
an edge orchestrator, executable by a processor to:
orchestrate execution of an application, wherein the application comprises a chain of services; and
cause a service in the chain of services to be executed by the first edge computing device;
wherein the first edge computing device is to:
receive data to be processed in the service;
analyze the data to determine characteristics of the data;
determine an opportunity to replicate the service to form multiple processing pipelines for the data based on the characteristics of the data;
perform data scaling on the data based on the opportunity;
initiate replication of the service on the second edge computing device based on the data scaling; and
generate a combined output for the service based on an output from execution of the service by the edge computing device and an output from execution of the replicated instances of the service by the second edge computing device.

19. The system of claim 18, wherein data scaling comprises at least one of replication of the data, segmentation of the data, elimination of at least a portion of the data, or performing a data transform on the data.

20. The system of claim 18, wherein the second edge computing device is selected to execute a replicated instance of the service based on one or more of availability of the second edge computing device, geographic location of the second edge computing device, or hardware features of the second edge computing device.
